(19) United States
(12) Patent Application Publication
(10) Pub. No.: US 2014/0316824 A1
(43) Pub. Date: Oct. 23, 2014

(54) INVENTORY AND PRICING METHOD AND COMPUTER PROGRAM PRODUCT

(71) Applicant: Howard Tkatch, Oak Park, MI (US)

(72) Inventor: Howard Tkatch, Oak Park, MI (US)

(21) Appl. No.: 14/224,527

(22) Filed: Mar. 25, 2014

Related U.S. Application Data
(60) Provisional application No. 61/804,843, filed on Mar. 25, 2013.

(51) Int. Cl. G06Q 40/08; G06Q 30/02

(52) U.S. Cl. CPC G06Q 40/08; G06Q 30/0283
USPC 705/4

(57) ABSTRACT

Methods for processing a claim between a claimant and an administrator divide the claim process into a series of discrete actions. The users may produce an itemized inventory of all property related to the claim by documenting the property and categorizing it based on a hierarchical organization system. Once the itemized inventory is produced, the users may generate pricing data to associate monetary values with the property items. In the context of an insurance claim, the parties may thereafter negotiate a compensation amount to be delivered to the insured claimant, who may use the compensation amount to repurchase the various property items listed in the itemized inventory. In the context of a bankruptcy or other matter, the itemized inventory and pricing data provide information as to potential debt payoff and asset valuation. A computer program product is disclosed with a program module having instructions for running the aforementioned methods.

### CROSS-REFERENCE TO RELATED APPLICATIONS

The present disclosure claims priority under 35 U.S.C. §119 under pending U.S. Provisional Patent Application Ser. No. 61/804,843, filed on Mar. 25, 2013, the disclosure of which is incorporated by reference.

### FIELD OF THE DISCLOSURE

The present disclosure relates to a method and computer program product for inventorying and pricing goods, and more particularly, to a method and computer program product for taking a complete inventory of a person or entity's property and thereafter assigning a price value to each specific property item based on market research and other comparisons.

### BACKGROUND

Disasters and destructive events can strike at any time and generally occur without warning. Whether they are natural, man-made, or financial, a disaster or destructive event poses a substantial and detrimental threat to one's property, which threat may result in such property being damaged or entirely destroyed. Many people own insurance policies as a precautionary means by which to protect themselves and their property; however, the process for reacquiring (or replacing) destroyed property, repairing damaged property, and seeking reimbursement for expenses incurred therein is a frustrating and extensive undertaking.

Generally, after a disaster or destructive event occurs, be it by fire, hurricane, or otherwise, the individual(s) whose property was damaged or destroyed files a claim with their insurance provider in order to begin the process for making themselves whole again. When a claim is filed, the insurance provider must take it upon itself to ascertain a complete inventory of the property that was damaged or destroyed by the event in question. It must then determine the actual cash value, or “ACV,” for each individual property item on its inventory list. These steps can take a significant amount of time to complete, as inventorying all of the claimant's property is a lengthy task, and determining the ACV for each item can be particularly difficult. Oftentimes, the claimant and the insurance provider will be unable to agree on a valuation for at least some property, which disagreement imposes additional delays that only further prolong the claims process.

The Internet has presented to insurance providers and consumers alike a better way to research market values for specific property from a variety of sources, such as online retailers, personal sale advertisements, and other pricing databases. Using the qualitative information obtained therefrom, both parties to an insurance claim can more effectively determine the ACV for each property item that is the subject of such a claim. However, manually researching pricing information prescribed on a multiplicity of websites is extremely time consuming and may not lead to conclusive results if multiple sources indicate a variance of valuations, which time and variance problems also further complicate the process.

Existing solutions for expediting the claims process include an Internet-based method for receiving inventory data, identifying the manufacturer of the various inventory items, acquiring pricing data for the inventory items, reporting the inventory and pricing data to an insurance provider, and determining any liability limits for the insurance claim. Such a method provides for the semi-automated generation and updating of inventoried property and price calculation therefore, which semi-automation drastically improves the manual research aspect of the claims process. Regardless, this method is nonetheless inefficient in that it still requires the claimant to take a complete inventory of each claim item and input that inventory thereto before it can begin generating and calculating pricing data, and further in that it requires each step thereof to be undertaken sequentially and in within a specific time limit.

Thus, while existing solutions allow a claimant to acquire pricing data for property items that have been damaged or destroyed, various drawbacks, including those mentioned above, remain.

Consequently, there exists a need for an inventory and pricing method and system that automates the claims process by allowing a user to generate an inventory of his or her affected property using various hierarchical databases and associates the items contained within various hierarchical databases with pricing data obtained from the database sources to further expedite the claims process, and which does not impose a time limit or a specific sequence in order to be executed.

### SUMMARY OF THE INVENTION

In view of the foregoing disadvantages of the prior art, an inventory and pricing method and system configured to include all the advantages of the prior art and to overcome the drawbacks inherent therein is provided. It is an object of the present disclosure to provide an inventory and pricing method and system that automates the claims process by allowing a user to produce an itemized inventory of the property that is the subject of an insurance claim and categorize each item therein based on a hierarchical system. It is further an object of the present disclosure to provide an inventory and pricing method and system that allows a user to generate pricing data obtained from various external sources and associate a monetary value with each item of the itemized list in order to expedite and otherwise advance the insurance claims process.

In an embodiment, a method for processing an insurance claim between an insured party and an insuring party comprises the steps of obtaining an itemized inventory for the subject property of the insurance claim, generating pricing data from one or more sources for each inventory item, associating a monetary value with each inventory item based on the pricing data generated, verifying that both parties to the claim transaction have approved the itemized inventory and monetary values associated therewith, delivering an initial reimbursement to the insured party based on an initial compensation amount, completing one or more transactions to repurchase the subject property of the insurance claim using the initial reimbursement, and maintaining a sales record for each such repurchase transaction. The itemized inventory may be created by documenting each item related to the insurance claim (i.e. each individual subject property thereof). The source from which the pricing data is generated may be an application programming interface, a product-centered price listing, a merchant-centered price listing, a crowd sourcing service, and a standard price aggregation. The monetary value may be equal to the average of the generated pricing data, or may equal some other value based thereon. If the insured and insuring parties have not both approved the itemized inventory and the monetary values associated therewith, the method permits the parties to repeat the previous steps thereof until mutual approval may be so verified. The initial reimbursement may be delivered to the insured party in the form of a negotiable instrument, such as a personal or cashier's check. The sales record from the repurchase transaction may be a sales receipt or other writing documenting the transaction in sufficient detail.

In a further embodiment, the method step of maintaining a sales record for each repurchase transaction may further comprise the steps of revising the itemized inventory, negotiating an additional reimbursement to be delivered to the insured party for an additional compensation amount, and finalizing one or more repurchase transactions using the additional compensation amount. The initial expense total is equal to the amount that the insured party has thus far spent on repurchasing the inventory items. The itemized inventory is revised by identifying the items thereof that have not yet been repurchased from the original itemized inventory. The additional reimbursement may be delivered to the insured party in the form of a negotiable instrument, as with the initial reimbursement.

In a further embodiment, the method may further comprise the step of computing a remaining replacement cost equal to the total amount that must be spent to replace all remaining items on the revised itemized inventory. If the additional compensation amount is less than the remaining replacement cost, the method permits the insured and insuring parties to repeat the aforesaid maintaining step in order to calculate and deliver to the insured party a corrected negotiable instrument in the amount of a corrected compensation amount equal to the difference between the additional compensation amount and the remaining replacement cost.

In a further embodiment, the method may further comprise the step of adjusting the monetary value of one or more items of the itemized inventory based on one or more identifiable characteristics of such item(s), which adjustment could occur between the associating and verifying steps. The identifiable characteristic may be any physical or other quality that tends to reduce or improve the value of the subject property item, such as scratches or dents on the fascia thereof.

In a further embodiment, documenting the various items of the itemized inventory may be done be one or more of barcode scanning the item(s), video recording a walkthrough of the item's or items' location, taking pictures of the item(s), recording an oration of the item(s), and using software to draft a list of such items.

In a further embodiment, each item of the itemized inventory may be organized within such inventory based on one or more preloaded categories that define the item. For example, the inventory may be organized based on rooms of a house, types of property, age of the property, etc.

In an embodiment, a computer program product comprises a program module having instructions for running the aforesaid processing an insurance claim between an insured party and an insuring party. The computer program product may be expressed in the aforesaid further embodiments as are discussed with respect to the aforesaid method.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawings and detailed description in which there are illustrated and described exemplary embodiments of the present disclosure.

### DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 shows an exemplary diagram of the various sources by which an itemized inventory or claim property may be documented in accordance with an exemplary embodiment of the present disclosure; and

FIG. 2 shows an exemplary flow chart illustrating the steps of the disclosed method for processing an insurance claim between an insured party and an insuring party in accordance with an exemplary embodiment of the present disclosure.

Like reference numerals refer to like parts throughout the description of several views of the drawings.

### DETAILED DESCRIPTION OF THE DISCLOSURE

The best mode for carrying out the present disclosure is presented in terms of its preferred embodiments, herein depicted in the accompanying figures. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure.

The terms “a” and “an” herein do not denote a limitation of quantity, but rather denote the presence of at least one of the referenced items.

The present disclosure comprises an inventory and pricing method and computer program product that divides the inventory process associated with an insurance claim and other matters (hereinafter collectively referred to as “claim”) into discrete actions. The method comprises the steps of categorically inventorying items that are the subject of a claim based on a hierarchical identification system, determining a monetary value for each item thereon and associating such value therewith, reviewing the items and associated valuations for accuracy, and facilitating communications between the parties involved in the claim, which, for instance, may be an insured claimant and his or her insurance provider (hereinafter referred to as “insured party” and “insuring party,” respectively). The communications generally involve the steps of granting an initial compensation amount to the insured party by the insuring party, and negotiating any additional compensation amount as may be required after the insured party exhausts the initial compensation amount repurchasing items from the itemized inventory.

The itemized inventory may be generated by recording and transcribing the insured party's and insuring party's itemized recitations of the property in question, which transcription may be done via first-party or third-party services. The value of the inventoried items may be determined by way of an automated price query, and the value can then be compared or verified by way of crowd sourcing or otherwise comparing the returned value against a set of pre-existing values for similar items. There may further be an option for the insured party to purchase a replacement item from the inventory, which purchase may be accounted for in the adjustment of the insured party's overall claim. The method allows at least one step thereof to be performed by a party other than the insured party, as may be necessary, and the method may pause after a particular step is performed, thus obviating performance of all steps thereof sequentially or within a specific time limit. The method may be implemented using electronic means and networked communications to facilitate the creation and constant updating of inventory and or pricing data, and may be executed electronically on a computer system.

In the event that an initial reimbursement delivered by the insuring party to the insured party is insufficient to repurchase each item of the itemized inventory, the method may further comprise calculating a price overage for use in determining an additional reimbursement to be negotiated by the insuring party. Should the additional reimbursement still be insufficient to repurchase the remaining items of the itemized inventory, a corrected reimbursement may be delivered to the insured party to finalize the insurance claim transaction.

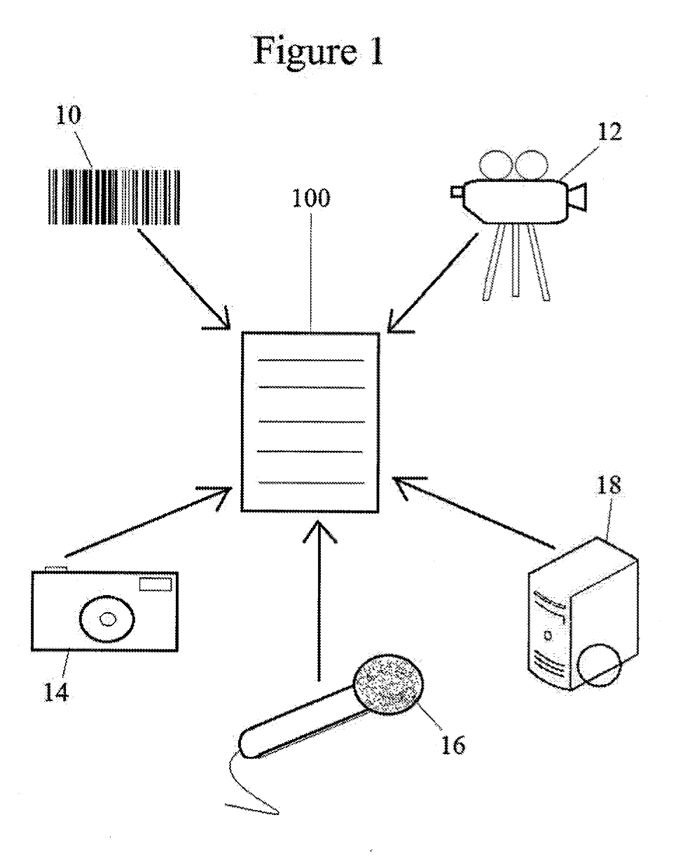

Referring now to FIG. 1, and in an embodiment, the first step of the method requires that an itemized inventory 100 be produced, which itemized inventory 100 reflects the complete set of property items that will be the subject of the insurance claim. Initially, a work order may be processed, which may include the insured party filing the original claim with the insuring party. The insured party and/or insuring party must then document the items for which the claim was filed, which may be accomplished via a plurality of means including, but not limited to, barcode scanning 10 to return a registered listing of the item, video recording 12 a walkthrough of the location in question and the items disposed therein, photographing 14 each individual item or the environments or locations in which the items are disposed, recording a spoken description 16 of each item, and utilizing a computer application 18 to assemble the list of items. In a preferred embodiment, and regardless of the particular means by which the property items are documented, the individual undertaking the documentation process will visually identify each property item of the itemized inventory so as to verify the item's existence and ensure accuracy of any objective characteristics (as will be discussed below).

The documenting process generates a preliminary set of data that may thereafter be supplemented by further defining the items listed, which may be done by perusing a plurality of preloaded categories and navigating to a desired destination thereof. In an embodiment, the plurality of preloaded categories preferably comprises a hierarchical system wherein items may be searched for based on one or more characteristics, such as where the property is located within the premises in question and the type of product most closely relating to the property. For example, when discerning a location, the hierarchical system may allow a user to select “House→Bedroom→Closet,” and when discerning a product, it may allow the user to select “Clothing→Pants→Blue Jeans→Boot Cut.”

In an embodiment, the products may be further defined based on the manufacturer, the age of the product, and any of another set of characteristics. By using a hierarchical system in this way, the preloaded categories help to narrow down the subsequent valuation searches by limiting the boundaries of those search queries to that which has already been discerned. Thus, defining each property item within a particular category of the hierarchical system benefits the user by thoroughly documenting his or her property so that the necessary information may be sufficiently gathered, which may expedite the entire insurance claim process.

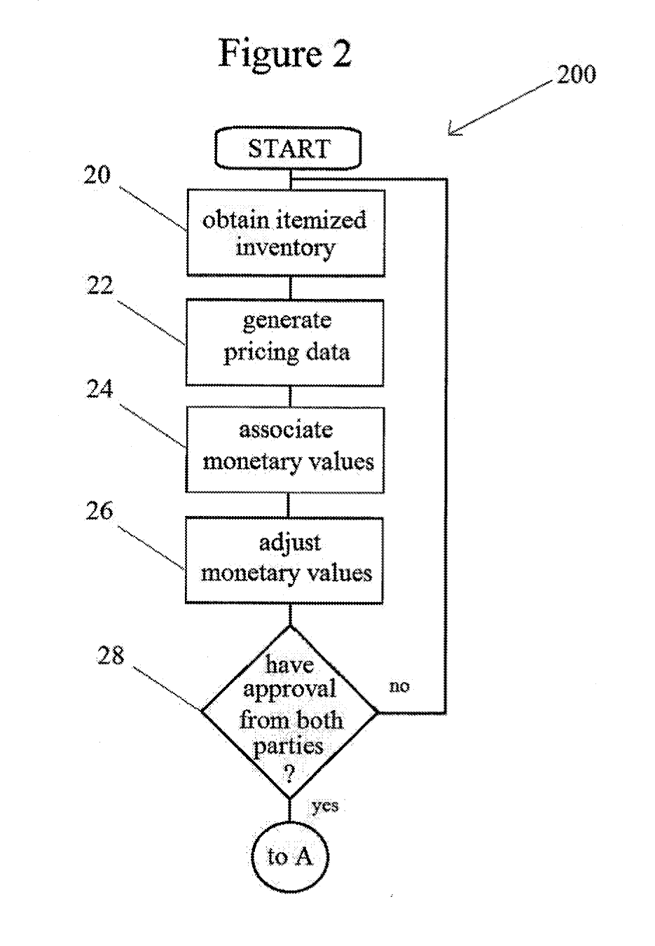

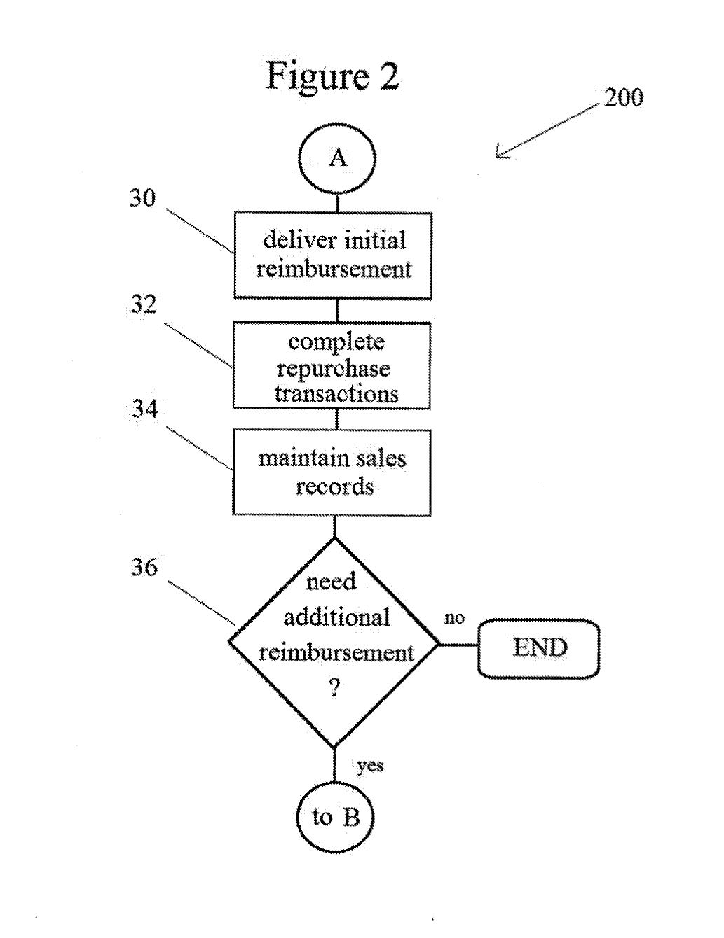

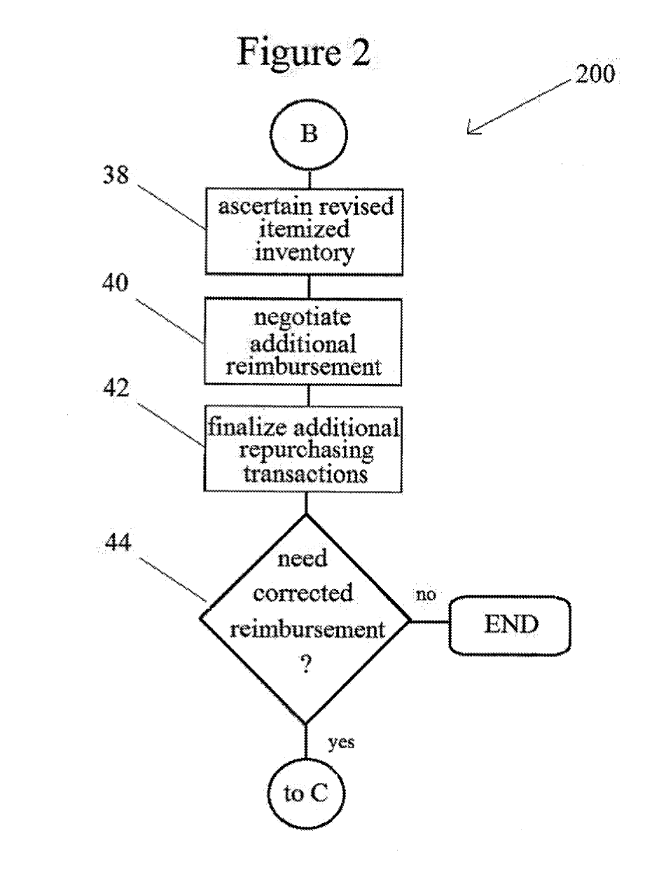

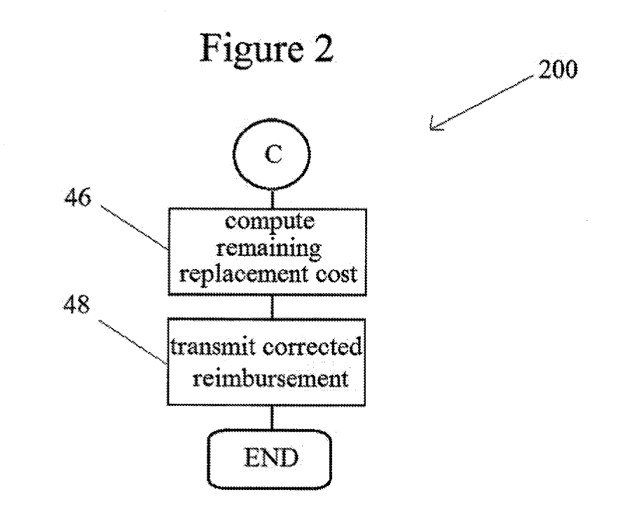

Referring now to FIG. 2, and in an embodiment, the first step 20 of the method 200 involves obtaining the aforementioned itemized inventory. That is, and previously stated, the method 200 first requires that an itemized inventory be produced as described above in order to discern the subject property of the insurance claim. Once the itemized inventory is obtained, the method 200 proceeds to the second step 22, which involves generating pricing data to determine the correct valuation for each item listed in the itemized inventory.

In an embodiment, the method 200 utilizes a database that is constantly being updated and otherwise maintained, which database may use application programming interfaces, or “APIs,” to generate current pricing data from various Internet sources, including without limitation Amazon® and eBay®. The APIs from these sources allow the database used by the method 200 to gather as much up to date information about the various items and their valuations as possible, which information may then used to determine the price or value with which each item on the itemized inventory is associated. That is, the sources corresponding to the APIs may include pricing information for one or more of the property items of the itemized inventory, which pricing information may be copied into the database utilized by the method 200 to maintain accurate valuation records. In a further embodiment, there may be other means by which to retrieve pricing data than via the aforementioned APIs, which other means may comprise product-centered price listings, merchant-centered price listings, crowd sourcing services, and standard price aggregations.

Regardless of the data retrieval means, the user will preferably be able to visually identify each item of the itemized inventory to ensure accuracy of the pricing data search queries, whether by observing the property firsthand or reviewing a documented video walkthrough or photograph set thereof. Should pricing data on any specific items or set thereof be irretrievable or otherwise unavailable, the method 200 will identify items that are similar to those as appear in such inventory and thereafter consider the relative pricing or valuations of those similar items in comparison with the specific inventory items.

Once pricing data is generated, the third step 24 of the method 200 will permit the user to associate the generated pricing data 22 with each respective item of the itemized inventory, which thus also provides a representative total monetary value for the claim as a whole. However, the fourth step 26 of the method 200 provides the parties to the transaction with the opportunity to adjust the monetary values associated with each item of the itemized inventory based on one or more objective characteristics thereof. That is, certain characteristics of each item of the itemized inventory should be considered, such as the approximate age, relative quality, and any unique features (such as collectable or marketable value), in order to determine whether the monetary value associated with a given property item of the itemized inventory should be increased above or decreased below the pricing data generated therefor. This value adjustment assists the claims process by discerning a more accurate ACV for the subject property items.

In an embodiment, fifth step 28 of the method 200 comprises verifying that both parties have approved the itemized inventory and the monetary values associated with each individual item thereof. This in part requires that each party to the transaction review the itemized inventory and pricing data associated with each property item for accuracy. Given that both the insured party and the insuring party must each approve the itemized inventory and associated pricing data, the order in which the parties do so may be immaterial. This review process may include confirming that any adjustments made to the monetary values associated with a given property item of the itemized inventory are valid and accurate. For example, the party undertaking such review may compare the determined ACV with the generated pricing data and monetary values already associated with each inventory item. Where the ACVs are consistent therewith, the reviewing party may verify the accuracy of the pricing data for the item under review. Where the ACVs are inconsistent therewith, the reviewing party may institute a dispute of claim amounts detailing the reason or reasons as to why the pricing data already associated with the inventory items is incomplete or inaccurate. Both the insured party and the insuring party are capable of instituting such a dispute of claim amounts.

A dispute of claim amounts occurring during the fifth step 28 of the method 200 mandates a discussion between the parties to the claim as to why the party instituting such dispute has arrived at a different monetary valuation result than that which has previously been associated with one or more property items of the itemized inventory. The parties may thereafter agree or disagree with the reason(s) for the dispute and resolve the discrepancies by amending the itemized inventory and/or the associated pricing data, or require that the claim be returned to the preceding second step 22 of the method 200, wherein a new set of pricing data to be associated will be generated based on a new search, which new search may take into account the objective characteristics that were determined for each claim item during the fourth step 26 of the method 200.

Once the insured party and the insuring party have each verified the accuracy of the pricing data for each item of the inventory, they may sign-off on or otherwise confirm their review thereof, which confirmation may be done electronically. Once both confirmations have been received, the parties are deemed to have approved the itemized inventory and associated monetary values, which approval is thus verified such that the method may proceed.

In an embodiment, the sixth step 30 of the method 200 comprises facilitating communications between the parties, and, in particular, granting an initial reimbursement having a value of an initial payout amount to be delivered to the insured party by the insuring party. Again, however, before this sixth step 30 may be performed, the method 200 must first ensure that the insured party and the insuring party (and any other party to the claim as may be necessary) have confirmed their reviews of the itemized inventory and associated pricing data and approved the same.

Once mutual approval is confirmed, the insuring party may calculate an initial compensation amount for the initial reimbursement to be paid out in the form of a negotiable instrument to the insured party in compensation for the claim filed. The insuring party may further calculate a holdback amount that may be available if necessary, but which holdback amount is not part of the initial compensation amount. Upon the insuring party having finalized the initial compensation amount, the negotiable instrument for the initial reimbursement is delivered to the insured party.

Thereafter, and in an embodiment, the seventh step 32 of the method 200 allows the insured party to repurchase at least some of the property items of the itemized inventory using the initial compensation amount of the initial reimbursement. However, given that the initial compensation amount may not be large enough to permit repurchasing of all property items of the itemized inventory (for example, due to the fact that a holdback amount may be retained by the insuring party with respect to the claim), prior to repurchasing any such items, the insured party may wish to determine the priority of repurchase for such items, as certain items may be needed more immediately than others. In any case, once the insured party commits to repurchasing certain claim items, they will be able to do so online, in person, or otherwise, as the method 200 does not impose any repurchase restrictions on the insured party.

In am embodiment, the insured party will be required to manage thorough records of all such repurchasing transactions, as provided by the eighth step 34 of the method 200. In a preferred embodiment, the repurchase transaction records comprise sales receipts prescribing the specific details of the transaction, including without limitation the products purchased and the total monetary amount of the sale; however, it is understood that various other records may suffice in this capacity so long as they accurately reflect at least information pertaining to the products purchased and the total monetary amount of the sale. Generally, these repurchase transaction records are required for the parties to benefit from having complete and accurate records of the entire claims process, but they may be subsequently used to calculate any price amounts in overage of the initial compensation amount received by the insured party.

Essentially, managing the repurchase transaction records requires the insured party to track exactly which items from the itemized inventory have already been repurchased, which will be useful later in determining whether it is necessary to calculate the prices for any items from the inventory that have yet to be repurchased and report on whether any additional compensation amount is necessitated for the insured party to repurchase all items from the inventory and what such amount should be. The insured party will preferably further be required to verify at any given time that accurate records of all repurchasing transaction receipts are maintained and readily accessible, should a request for the same be made, for example, by the insuring party.

During its next step 36, the method 200 requires the user to consider the need for further reimbursement negotiations between the insured party and the insuring party. In the event that all items of the itemized inventory may be repurchased using the initial compensation amount of the initial reimbursement, or if the insured party waives his or her need to repurchase certain items thereof, the method 200 is deemed fully performed and the insurance claim may finalize and close. Contrastingly, if the insured party determines that not all items can be repurchased using the initial compensation amount of the initial reimbursement (e.g., if the insured party's report indicates that an additional compensation amount is necessitated), a subsequent overage negotiation may be required to adequately calculate all further costs necessary to repurchase the remaining items of the itemized inventory and to accordingly pay out an additional compensation amount to the insured party. Notwithstanding the foregoing, and in a preferred embodiment, the stun of the initial compensation amount and any additional compensation amount may not be greater than the sum of the ACVs for all of the property items of the itemized inventory.

The subsequent negotiation may involve deliberations between the insured party and the insuring party before the insuring party delivers an additional reimbursement for an additional compensation amount to the insured party. Alternatively, the subsequent negotiations may be obviated by the parties' mutual assent and may instead permit the immediate delivery of an additional reimbursement for the additional compensation amount to the insured party. In an embodiment, the additional, compensation amount may comprise the aforementioned holdback amount and/or some other amount (which when added to the initial compensation amount will preferably not exceed the calculated ACVs of the yet to be purchased items).

Specifically, the next step 38 of the method 200 may comprise ascertaining a revised itemized inventory to account for each of the property items that remain unpurchased. That is, the insured party and/or insuring party may peruse the repurchase transaction records (e.g. sales receipts) to determine which items have not yet been repurchased or replaced. Once the revised itemized inventory is ascertained, the next step 40 of the method 200 involves calculating an additional compensation amount that may be negotiated and delivered to the insured party by the insuring party. The additional compensation amount generally will be equal to the sum of the monetary values associated with each item of the revised itemized inventory.

In an embodiment, the additional compensation amount may be reduced based on a payment overage calculated from the initial compensation amount. That is, a payment overage may be calculated by subtracting the initial expense total from the initial compensation, wherein the initial expense total is equal the sum of the repurchase prices of the property items of the itemized inventory that have already been replaced (i.e. those items of the itemized inventory that are not also included within the revised itemized inventory). Should a payment overage exist, the additional compensation amount may be reduced by the amount of the payment overage, as the insured party is presumed to already be in possession of those funds and further provision may cause the total compensation amount to exceed the total ACVs for the property items of the itemized inventory.

Once the additional compensation amount is finalized, an additional reimbursement in the amount of the additional compensation amount is delivered to the insured party by the insuring party. In the next step 42 of the method 200, the insured party, upon receiving the additional reimbursement, may continue the repurchasing process as described above until the additional compensation amount is exhausted or each item from the itemized inventory is repurchased.

The next step 44 of the method 200 asks the insured party and the insuring party to confirm whether the additional reimbursement was sufficient for the insured party to repurchase all remaining items of the revised itemized inventory, or otherwise confirm whether the insured party waives the need to repurchase the same. In the event that the additional reimbursement amount is sufficient or the insured party waives the need for further repurchasing, the method 200 is deemed completed and the insurance claim is finalized and closed. In the event that the parties deem the additional reimbursement insufficient for allowing the insured party to repurchase the remaining items of the revised itemized inventory, the method 200 proceeds to the next step 46 for computing a corrected compensation amount by closely evaluating the ACV for each item of the revised itemized inventory and comparing the sum thereof to the additional compensation amount. The corrected compensation amount may, during the next step 48, be delivered to the insured party as a corrected reimbursement in the form of a negotiable instrument as with the initial and additional compensation amounts, and as described above. Once this is delivered, the method 200 is deemed completed and insurance claim is finalized and closed.

In finalizing and closing the insurance claim, and in an embodiment, the parties may peruse all documentation associated with the claim to verify that all items from the itemized inventory (and revised itemized inventory, as applicable) have been accounted for in some capacity and that the insured party has received and processed all reimbursement and compensation amounts issued by the insuring party. A copy of all documentation may be given to the insured party for his or her own personal records. The parties may conduct correspondence to indicate that a final agreement has been reached between them, and each party may thereafter sign-off or otherwise confirm their concurrence with such final agreement. The insuring party may then finally draft and deliver to the insured party a report indicating the status of the claim as closed.

Another method is disclosed, which other method may further operate in situations not relating to the filing of an insurance claim. For instance, and in an exemplary embodiment, this method may be used in bankruptcy proceedings wherein the insured party is the debtor, and the insuring party is the bankruptcy trustee, and obtaining the inventory items at the prices associated therewith is done in order to satisfy existing debts owed to creditors. However, it is understood that the generality of the other method provides for applicability to a multitude of other situations involving a claimant and an administrator.

That is, this method is directed towards ascertaining an itemized inventory of property items and associated monetary values obtained through the substantially the same processes as with the previously-disclosed method. For example, where the subject situation relates to a bankruptcy proceeding or similar claim matter, it must still be understood what property is at the center of the claim and the value of such property. Because of this, the other method similarly teaches documenting the property items of the itemized inventory by any one or more of barcode scanning the property items, video recording a walkthrough of the location of the property items, photographing images of the property items, recording an oration of the property items, and utilizing a computer application to draft a list of the property items. Further, this method also teaches associating monetary values with the property items by generating pricing data from any one or more of an application programming interface, a product-centered price listing, a merchant-centered price listing, a crowd sourcing service, and a standard price aggregation.

This method allows the parties thereto to adjust the monetary value for any item of the itemized inventory based on its physical or other qualities, for example, such as scratches or damage to the aesthetic or by notating the item as a rare collectable. As with the previously-disclosed method, this method further requires that the claimant and the administrator verify the itemized inventory and associated monetary values by approving the same. In the event that the parties are unable to mutually or individually approve either or both of the itemized inventory and associated monetary values, the method allows the parties to repeat certain steps thereof to modify one or both of the same until they are in a condition for mutual approval and verification. Once the parties have approved the itemized inventory and the associated monetary values, the method is completed.

In another embodiment, a computer program product is disclosed as comprising a program module having instructions for executing the various steps of the disclosed method. The method and computer program product, in providing for the complete management and disposition of the property listed in an itemized inventory, allow an insured party and an insuring party to expedite the insurance claims process by automating the various steps thereof via electronic means and communications. In an embodiment, the insured party and insuring party may interface through a website, which website comprises a program module having instructions for running the method herein disclosed. In this way, the parties may have full access to each step of the method at any time from any Internet-accessible computer in the world. In another embodiment, the method may automate the repurchasing step thereof by connecting the insured party with online vendors who sell the items necessitating such repurchase.

It should be understood that the method and computer program product disclosed herein may be performed in discrete steps or sub-steps, and that it further may be interrupted such that the method and computer program product are not subject to temporal requirements mandating performance of any portion thereof within any particular limited or set of time. It should further be understood that the method and computer program product may, but need not, be performed on one or more systems, such as a personal computer or smart phone connected to the Internet, and that the various discrete steps of sub-steps thereof may thus each be performed on distinct systems, as may be necessary.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A method for documenting personal property and associated monetary values for a claim between a claimant and an administrator, the method comprising the steps of:
obtaining an itemized inventory by documenting each item related to the claim;
generating pricing data from at least one valuation source for at least one item of the itemized inventory
associating a monetary value with the at least one item of the itemized inventory based on the pricing data corresponding to the at least one item;
adjusting the monetary value of the at least one item of the itemized inventory as necessary based on at least one identifiable characteristic of the at least one item; and
verifying that the claimant and the administrator have each approved the itemized inventory and the monetary value of the at least one item of the itemized inventory,
wherein if, by said verifying step, the claimant and the administrator have not each approved the itemized inventory and the monetary value of the at least one item of the itemized inventory, the claimant and the administrator may repeat at least one of said obtaining step, said generating step, and said associating step until each has approved the itemized inventory and the monetary value of the at least one item of the itemized inventory.

2. The method of claim 1, wherein the documenting of said obtaining step may be undertaken by at least one of barcode scanning the at least one item, video recording a walkthrough of a location in which the at least one item is located, photographing images of the at least one item, recording an oration of the at least one item, and utilizing a computer application to draft a list of the at least one item.

3. The method of claim 1, wherein the at least one item may be organized within the itemized inventory based on at least one preloaded category used to define the at least one item.

4. The method of claim 1, wherein the pricing data of said generating step is obtained using at least one of at least one application programming interface for the at least one valuation source, a product-centered price listing, a merchant-centered price listing, a crowd sourcing service, and a standard price aggregation.

5. A method for processing an insurance claim between an insured party and an insuring party, the method comprising the steps of:
obtaining an itemized inventory by documenting each item related to the insurance claim;
generating pricing data from at least one valuation source for at least one item of the itemized inventory
associating a monetary value with the at least one item of the itemized inventory based on the pricing data corresponding to the at least one item;
verifying that the insured party and the insuring party have each approved the itemized inventory and the monetary value of the at least one item of the itemized inventory;
delivering an initial reimbursement by calculating an initial compensation amount and thereafter transmitting an initial negotiable instrument for the initial compensation amount;
completing at least one transaction to purchase a replacement for the at least one item of the itemized inventory at a sales price using the initial compensation amount; and
maintaining a sales record from the at least one transaction, the sales record including a sales price,
wherein if, by said verifying step, the insured party and the insuring party have not each approved the itemized inventory and the monetary value of the at least one item of the itemized inventory, the insured party and the insuring party may repeat at least one of said obtaining step, said generating step, and said associating step until each has approved the itemized inventory and the monetary value of the at least one item of the itemized inventory.

6. The method of claim 5, wherein said maintaining step further comprises the steps of:
ascertaining a revised itemized inventory by identifying the at least one item of the itemized inventory that was not replaced during said completing step;
negotiating an additional reimbursement by calculating an additional compensation amount and thereafter transmitting an additional negotiable instrument for the additional compensation amount; and
finalizing at least one transaction to purchase a replacement for the at least one item of the revised itemized inventory at a revised sales price using the additional compensation amount.

7. The method of claim 6, wherein the method further comprises the step of computing a remaining replacement cost, the remaining replacement cost equaling the sum of the monetary value of the at least one of item of the revised itemized inventory, said computing step occurring after said maintain step, and
wherein if the additional compensation amount is less than the remaining replacement cost, the insured party and the insuring party may repeat said maintaining step in order to calculate a corrected compensation amount and thereafter transmit a corrected negotiable instrument for the corrected compensation amount.

8. The method of claim 5, wherein the method further comprises the step of adjusting the monetary value of the at least one item of the itemized inventory as necessary based on at least one identifiable characteristic of the at least one item, said adjusting step occurring in between said associating step and said verifying step.

9. The method of claim 5, wherein the documenting of said obtaining step may be undertaken by at least one of barcode scanning the at least one item, video recording a walkthrough of a location in which the at least one item is located, photographing images of the at least one item, recording an oration of the at least one item, and utilizing a computer application to draft a list of the at least one item.

10. The method of claim 5, wherein the at least one item may be organized within the itemized inventory based on at least one preloaded category used to define the at least one item.

11. The method of claim 5, wherein the pricing data of said generating step is obtained using at least one of at least one application programming interface for the at least one valuation source, a product-centered price listing, a merchant-centered price listing, a crowd sourcing service, and a standard price aggregation.

12. The method of claim 5, wherein the sales record of said maintain step is a sales receipt.

13. A computer program product embodied on a storage medium for processing an insurance claim between an insured party and an insuring party, the computer program product comprising a program module having instructions for:
obtaining an itemized inventory by documenting each item related to said insurance claim;
generating pricing data from at least one valuation source for at least one item of said itemized inventory
associating a monetary value with said at least one item of said itemized inventory based on said pricing data corresponding to said at least one item;
verifying that said insured party and said insuring party have each approved said itemized inventory and said monetary value of said at least one item of said itemized inventory;
delivering an initial reimbursement by calculating an initial compensation amount and thereafter transmitting an initial negotiable instrument for said initial compensation amount;
completing at least one transaction to purchase a replacement for said at least one item of said itemized inventory at a sales price using said initial compensation amount; and
maintaining a sales record from said at least one transaction, said sales record including a sales price,
wherein if, by said verifying instructions, said insured party and said insuring party have not each approved said itemized inventory and said monetary value of said at least one item of said itemized inventory, said insured party and said insuring party may repeat at least one of said obtaining instructions, said generating instructions, and said associating instructions until each has approved said itemized inventory and said monetary value of said at least one item of said itemized inventory.

14. The computer program product of claim 13, wherein said maintaining instructions further comprise instructions for:
ascertaining a revised itemized inventory by identifying said at least one item of said itemized inventory that was not replaced during said completing instructions;
negotiating an additional reimbursement by calculating an additional compensation amount and thereafter transmitting an additional negotiable instrument for said additional compensation amount; and
finalizing at least one transaction to purchase a replacement for said at least one item of said revised itemized inventory at a revised sales price using said additional compensation amount.

15. The computer program product of claim 14, wherein said program module further comprises instructions for computing a remaining replacement cost, said remaining replacement cost equaling the sum of said monetary value of said at least one of item of said revised itemized inventory, and
wherein if said additional compensation amount is less than said remaining replacement cost, said insured party and said insuring party may repeat said maintaining instructions in order to calculate a corrected compensation amount and thereafter transmit a corrected negotiable instrument for said corrected compensation amount.

16. The computer program product of claim 13, wherein said program module further comprises instructions for adjusting said monetary value of said at least one item of said itemized inventory as necessary based on at least one identifiable characteristic of said at least one item.

17. The computer program product of claim 13, wherein said documenting of said obtaining instructions may be undertaken by at least one of barcode scanning said at least one item, video recording a walkthrough of a location in which said at least one item is located, photographing images of said at least one item, recording an oration of said at least one item, and utilizing a computer application to draft a list of said at least one item.

18. The computer program product of claim 13, wherein said at least one item may be organized within said itemized inventory based on at least one preloaded category used to define said at least one item.

19. The computer program product of claim 13, wherein said pricing data of said generating instructions is obtained using at least one of at least one application programming interface for said at least one valuation source, a product-centered price listing, a merchant-centered price listing, a crowd sourcing service, and a standard price aggregation.

20. The computer program product of claim 13, wherein said sales record is a sales receipt.
